(19) United States
(12) Patent Application Publication
(10) Pub. No.: US 2009/0207078 A1
(43) Pub. Date: Aug. 20, 2009

(54) Beam steering in a MIMO system

(75) Inventors: Paul Nicholas Fletcher, Bristol (GB); Michael Dean, Worcestershire (GB); Paul Anthony Hickling, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 11/631,085

(22) PCT Filed: Jul. 4, 2005
(86) PCT No.: PCT/GB2005/002591

§ 371 Date: Apr. 23, 2009

(30) Foreign Application Priority Data
Jul. 2, 2004 (GB) 0414889.6

(51) Int. Cl. H04B 7/06

(52) U.S. Cl. 342/377; 342/368

(57) ABSTRACT

Method, apparatus, associated computer programs, and signals for channel identification in Multiple-Input Multiple-Output (MIMO) communications systems, and in particular wireless communications systems. The channel derivation method uses steering of mutually orthogonal beamformers at the transmitter end to allow direct identification, whether by selection or mathematical computation, of the channel matrix and hence the preferred transmit beam orientations.

### FIELD OF THE INVENTION

The present invention relates to apparatus, methods, signals, and programs for a computer for Multiple-Input Multiple-Output (MIMO) communications systems and systems incorporating the same. In particular the invention relates to channel matrix identification in such systems. Such systems may be used, for example, in wireless communications systems.

### BACKGROUND TO THE INVENTION

Much recent research has been directed towards the field of wireless communications systems which employ a Multiple-Input Multiple-Output (MIMO) architecture. Such systems use communications channels employing antennas consisting of multiple elements at both the transmitter and receiver end of the communications link. It has been shown (for example by G. J. Foschini and M. J. Gans, in “On Limits of Wireless Communications in a Fading Environment When Using Multiple Antennas”, Wireless Personal Communications, Vol. 6, No. 3, March 1998, p. 311) that—provided sufficient multi-path activity exists within a given channel such that each element experiences independent spatial fading—by use of suitable signal processing means, the data rate available over a given communications channel is proportional to the lesser of the number of transmit elements and receive elements. In an indoor channel—for example that of a wireless local area network—such conditions are commonly met when the radiating elements are placed at approximately half-wavelength separation or greater.

The advances in the theoretical aspects of MIMO channel characterisation and their data communication capacity have been undertaken in parallel with developments in advanced spatial processing methods for detection and decoding of data streams sent over MIMO channels. One of the most celebrated and simplest methods was developed by Foschini (“Layered Space-Time Architecture for Wireless Communication in a Fading Environment When Using Multiple Antennas”, Bell Labs. Tech. Journal, Vol 1, No 2, Autumn 1996, pp. 41-59).

MIMO technologies are currently under consideration both for next generation wireless systems and as potential upgrades to existing systems such as those based upon IEEE 802.11a, IEEE 802.11b, and Bluetooth standards as well as mobile communication systems (e.g. UMTS). Such approaches are commercially attractive since they offer potentially significant increases in channel capacity as compared with existing systems—and hence systems can support increased numbers of users and thereby generate increased revenue for network operators. MIMO technology thereby offers potential increases in effective data transmission capacity without a corresponding increase in allocation or consumption of the most valuable of communication resources, namely bandwidth and power.

Common to the practical implementation of known advanced wireless systems employing coherent modulation and demodulation (and hence a high quality robust communications link/high capacity) is the need to perform channel estimation. That is, the receiver system must undertake a procedure to estimate the complex channel gain between the transmitter and receiver. An estimate of the complex channel gain is required in order to allow mitigation of the detrimental effects associated with such complex channel gain. In wideband systems the estimation process may entail obtaining multiple estimates extending in the temporal and/or frequency domain so as to address the variation in complex channel gain which may occur both over time and over a given frequency range at any given time. In known systems this process commonly requires transmission of a predetermined training sequence which is known by the receiver. By comparing the known training sequence with the received signal the receiver can derive an estimate of the channel. Since channel estimation must be applied repeatedly—over frequency and over time—in order that the changing wireless channel can be adequately tracked by the receiver, this entails repeatedly transmitting the training sequence, thereby occupying bandwidth which could otherwise be utilised for profitable data transmission.

In known systems the complexity of channel estimation for MIMO channels rises with the product of the number of transmit and number of receive antennas, since each receive antenna must estimate the complex channel gain between each transmit antenna and itself. So for example, in a 2×2 MIMO system 4 channel estimates are performed whilst in a 4×4 MIMO architecture there are 16 channel estimates to be performed.

Consequently, a system initially designed for Single-Input Single-Output (SISO) operation would have to be significantly modified, in terms of required channel estimation training sequences, to allow for MIMO channel estimation.

The following published International Patent Applications also relate to MIMO systems: WO 03/041300 A1 (Qualcomm), WO 03/073552 A1 (Nortel Networks), WO 02/087108 A1 (Koninklijke Philips), WO 2004/038984 A1 (Qualcomm), WO 03/058871 A1 (Qualcomm), WO 03/050968 A2 (Qualcomm), WO 2004/054191 A1 (Qualcomm), WO 2004/038988 A2 (Qualcomm), and WO 2004/008657 A1 (Qualcomm).

### SUMMARY OF THE INVENTION

The present invention provides method, apparatus, and programs for computers for channel selection in communications systems, especially wireless communications systems.

According to a first aspect of the present invention there is provided a method of transmitting signals for MIMO systems using orthogonal transmit beams to characterise the channel.

In particular there is provided a method of transmitting signals for a multiple-input, multiple-output communications system, the method comprising the steps of: steering a set of mutually orthogonal transmit beams over a plurality of predetermined orientations; selecting a preferred orientation of the mutually orthogonal transmit beams responsive to a characteristic of signals received, at a receiver, from the transmit beams.

In one embodiment, the plurality of predetermined orientations substantially spans the available transmit space.

In a further embodiment, the characteristic is a measure of orthogonality of the received signals.

In a further embodiment, the selected orientation is one of the plurality of predetermined orientations.

In a further embodiment, the selected orientation need not be one of the plurality of predetermined orientations.

In a further embodiment, the selected orientation is computed from characteristics of the received signals.

In a further embodiment, the plurality of predetermined orientations is insufficient to substantially span the transmit space.

In a further embodiment, the plurality of predetermined orientations consists of two orientations.

In a further embodiment, the preferred orientation is selected responsive to a mathematical calculation applied to a characteristic of the received signals.

In further embodiments, the number of transmit beams is one of 2, 3, and 4.

In a further embodiment, selection is made responsive to receipt of an indication identifying a transmit orientation.

The method may be used in a wireless communications system.

In some embodiments, transmission of data continues during steering of the transmit beams.

In a further embodiment, a modulation level of at least one transmit beam is selected responsive to a characteristic of the received signals.

In a further embodiment, the characteristic is complex channel gain.

In a further embodiment, a modulation level is selected to be zero.

In a further embodiment, the modulation level is selected to be zero where the complex channel gain is measured to be every small.

According to a further aspect of the invention there is provided receiver apparatus for a communications system arranged to perform the methods associated with the invention.

In particular there is provided a receiver for a multiple-input, multiple-output communications system, the receiver comprising: receive apparatus arranged to receive signals from a set of mutually orthogonal transmit beams steered over a plurality of predetermined orientations; apparatus arranged to determine, for each predetermined orientation, a characteristic of the signals received by the receive apparatus, the characteristic being indicative of quality of the signals received by the receive apparatus; apparatus arranged to transmit at least one of (a) the characteristic of a plurality of, or all, predetermined orientations and (b) an indication of a preferred orientation, the indication being derived responsive to the characteristics of the signals received.

According to a further aspect of the invention there is provided transmitter apparatus for a communications system arranged to perform the methods associated with the invention.

In particular there is provided a transmitter for a multiple-input, multiple-output communications system, the transmitter comprising: beam steering apparatus arranged to steer a set of mutually orthogonal transmit beams over a plurality of predetermined orientations; selection apparatus for selecting a preferred orientation of the mutually orthogonal transmit beams responsive to a characteristic of signals received, at a receiver, from the transmit beams.

The invention also provides for a system for the purposes of communications which comprises one or more instances of apparatus embodying the present invention, optionally combined with other additional apparatus.

In particular, there is provided a communications system comprising a receiver and a transmitter according to preceding aspects.

In some embodiments the apparatus, whether receiver, transmitter or both in combination, is portable apparatus. Such equipment may include, but is certainly not limited to, mobile phones, portable digital assistants (PDA's), portable computers, and handheld data recording equipment, etc.)

The invention also provides for a computer chip set (including the case where the set comprises only a single chip) arranged to perform the foregoing methods. Such chip sets constitute apparatus and systems as described above.

The invention also provides for computer software in a machine-readable form and arranged, in operation, to carry out each function of the apparatus and/or methods. In this context such a computer program are understood to encompass code at any level (e.g. source code, intermediate code, object code, or any other “level”), and furthermore to include code designed to be compiled either to implement the invention directly, to create a computer simulation of the invention, or to create physical layout of computer circuits or chips capable of embodying the invention.

In particular, there is provided a program for a computer for a multiple-input, multiple-output communications system, the program comprising code portions arranged to: steer a set of mutually orthogonal transmit beams over a plurality of predetermined orientations; select a preferred orientation of the mutually orthogonal transmit beams responsive to a characteristic of signals received, at a receiver, from the transmit beams.

There is also provided a program for a computer for a multiple-input, multiple-output communications system, the program comprising code portions arranged to: receive signals from a set of mutually orthogonal transmit beams steered over a plurality of predetermined orientations; determine, for each predetermined orientation, a characteristic of the signals received by the receive apparatus, the characteristic being indicative of quality of the signals received by the receive apparatus; transmit at least one of (a) the characteristic of a plurality of, or all, predetermined orientations and (b) an indication of a preferred orientation, the indication being derived responsive to the characteristics of the signals received.

The invention is also directed to signals employed by the other aspects of the invention.

In particular, there is provided a signal for a multiple-input multiple-output communications system, the signal comprising a plurality of mutually orthogonal transmit beams carrying a training sequence, the transmit beams being steered over a predetermined set of orientations.

According to a further aspect of the invention there is provided a communications service provided over a communications network arranged to perform the method according to preceding aspects.

The method effectively replaces channel estimation by channel computation in MIMO systems. The overall complexity of calculations required is reduced as compared with known methods, with consequent reduction in the time required to perform the method.

Furthermore the need for lengthy training sequences (per individual transmit and receive antenna pair in known systems) is significantly reduced.

The present methods may be used to perform channel estimation without the need to significantly modify a Single-Input Single-Output (SISO) system in that is there is no need to modify existing SISO systems to send extra MIMO training sequences. SISO communications can continue at the same time as the MIMO channel is estimated which is commercial desirable.

During channel identification, the system can drop back to a lower transmission rate, for example allowing SISO transmissions to continue over the channel during channel identification.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of communication apparatus in accordance with the present invention;

FIG. 2 shows example matrices representing a transmission medium in accordance with the present invention;

FIG. 3 shows a further schematic diagram of communication apparatus in accordance with the present invention;

FIG. 4(a) shows a schematic graph illustrating how the absolute value of the reciprocal of the dot product of received beams' output varies as a function of φ in accordance with the present invention;

FIG. 4(b) shows a schematic graph illustrating how the absolute value of the reciprocal of the dot product of received beams' output varies as a function of θ in accordance with the present invention;

FIG. 5 shows a schematic graph illustrating how, in accordance with the present invention, the absolute value of the reciprocal of the dot product of received beams' varies across the whole search space;

FIG. 6 shows a further schematic diagram of communication apparatus in accordance with the present invention;

FIG. 7 shows a schematic diagram of a method in accordance with the present invention.

### DETAILED DESCRIPTION OF INVENTION

The present invention provides methods of deriving values for a MIMO channel which exploit the structure of the channel matrix in terms of its singular value decomposition (SVD). Such methods may require fewer channel training sequences than known systems. The invention directly finds the channel in its most “natural” form and thereby facilitates optimal communication.

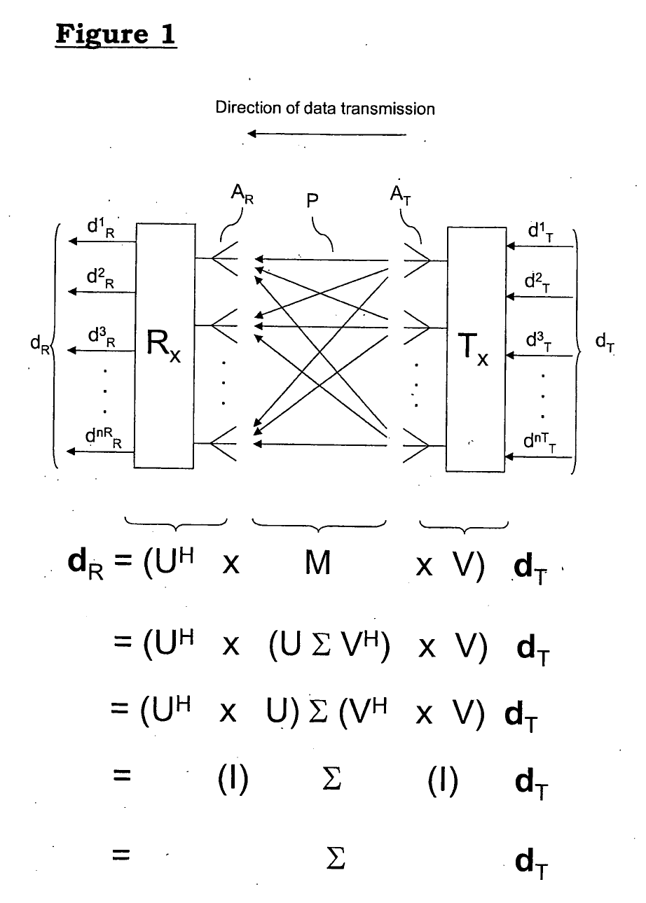

Referring to FIG. 1, a possible Multiple Input Multiple Output (MIMO) system comprises a transmitter system comprising a transmit beamformer Tₓ coupled to multiple transmit antenna elements A_{T} and a receive system comprising a receive beamformer Rₓ coupled to multiple receive antenna elements A_{R}. The transmitter elements are arranged to operate in conjunction with each other to form multiple transmit beams to the receiver, each transmit beam being formed by the emissions of multiple transmitter elements.

Signal vector d_{T} provided to the transmitter system for onward transmission is transmitted from the transmit antennas over multiple individual paths P in a suitable transmission medium M to the receiver from which the received signal vector d_{R} is recovered for onward transmission. Elements, dⁱ_{T}, of the data vector d_{T} are transmitted in parallel.

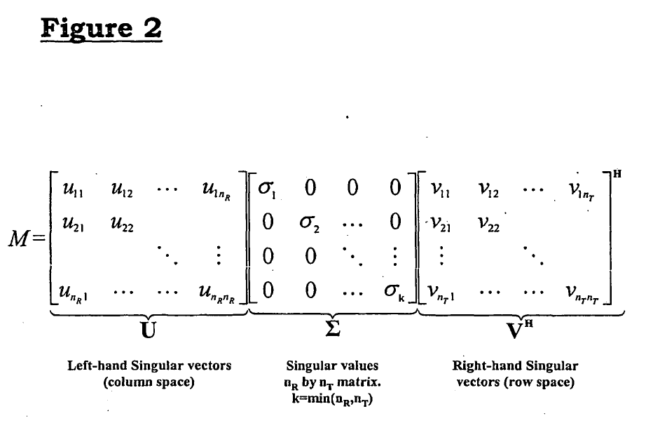

The data transformations associated with the transmitter medium and receiver can each be represented by a matrix acting upon the data as it passes through the system. In particular, and referring now to FIG. 2, it is known from the theory of SVD that any channel matrix M—representing the transformation effected by the transmission medium M and consisting of n_{R} rows and n_{T}, columns, where n_{R} is the number of receive antenna elements and n_{T}, is the number of transmit antenna elements—can be expressed as:

M=UΣV^{H} (1)

where U and V are orthonormal matrices spanning the row and column space of M respectively, where Σ is a matrix whose diagonal elements, σᵢ, are the singular values which connect the row and columns spaces of U and V^{H} whereby to construct M, and where (.)^{H} denotes the complex conjugate (Hermitian) transpose operation.

The form of this SVD is useful since it illustrates that in the optimum case in which the correct set of orthogonal beams, determined by matrix V, are formed by the transmitter, then a set of orthogonal receive beams U^{H} can be formed at the receiver such that the receive beams are mutually orthogonal and each is decoupled from all but one of the transmit beams. That is:

$$\begin{matrix}{d}_{R} = ( {U}^{H} \times M \times V ) {d}_{T} \\ = ( {U}^{H} \times ( U {ΣV}^{H} ) \times V ) {d}_{T} \\ = ( {U}^{H} \times U ) Σ ( {V}^{H} \times V ) {d}_{T} \\ = ( l ) Σ ( l ) {d}_{T} \\ = Σ {d}_{T}\end{matrix} \qquad ( 2 )$$

where Σ represents the channel gains. Matrix Σ is a diagonal matrix in which each element is the channel gain (not complex) of each of the orthogonal channels.

This creates the opportunity to estimate M by searching for the correct orthogonal transmit beam set V and testing for the orthogonality condition at the receiver.

When all conditions are met, then U and V are identified and the power in each orthogonal pair can be measured and is simply the appropriate value in Σ². Hence the channel matrix M, which characterises the transmission medium, is found.

In a first embodiment, it is necessary to perform a search process for suitable beamformers. The search for suitable beamformers may be undertaken by using orthogonal beamformers at the transmitter. An orthogonal beamformer at the transmitter may be denoted by a matrix B whose columns are orthogonal. This beamformer may then be steered over orthogonal beamforming space by means of a second unitary steering matrix J. J must be unitary (orthogonal) since the transformation that it performs must contain orthogonal beams. The receiver-transmitter relationship, relating the data d_{T} input to the transmitter to the data d_{R} output by the receiver, is then given by:

d_{R}=(UΣV^{H})×(JB)d_{T} (3)

B can be any n_{T} by n_{T} orthogonal matrix. It may for example be a Fourier orthogonal set, which can be easily found.

It can be shown that for the 2 by 2 case the matrix J has the form

$$J = [ \begin{matrix}c & {s}^{*} \\ - s & c\end{matrix} ] \qquad ( 4 )$$

where c=cos θ, s=|sin θ|e^{jφ}. The aim is to identify a suitable value of J such that matrix JB is orthogonal to V. Varying the values of θ and φ steers the orthogonal beamforming matrix B over the available beamforming space and, for the correct choice of parameters at the transmitter and receiver, the output received beams will be orthogonal so that:

d_{R}=Σ×d_{T} (5)

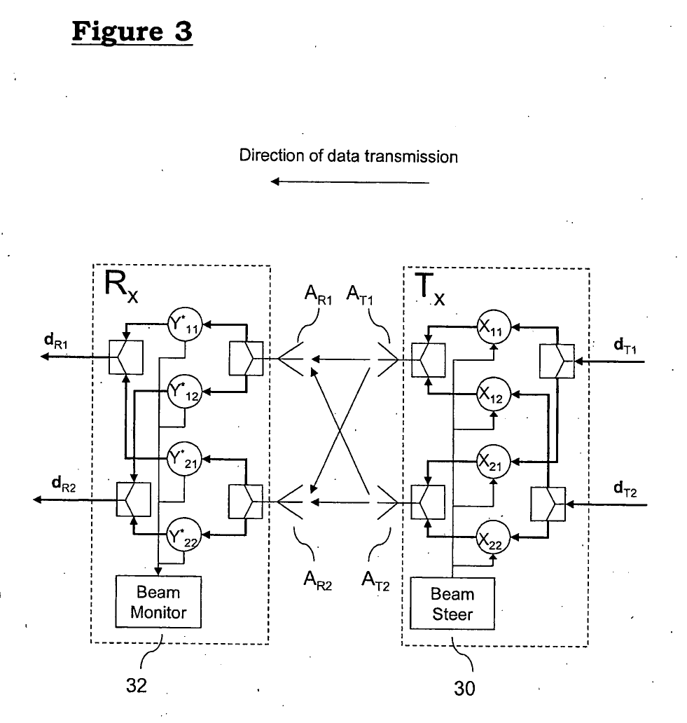

Referring now to FIG. 3, consider specifically the case of two transmit antenna elements A_{T1}, A_{T2} and two receiver antenna elements A_{R1}, A_{R2} and a channel matrix M. In the example given below, a specific value of M is derived from a stochastic model assuming independent Rayleigh fading channels between all transmit and receive antenna pairs:

$$M = [ \begin{matrix}- 0.3059 - j0 .8107 & 0.0886 + j0 .8409 \\ - 1.1777 + j0 .8421 & 0.2034 - j0 .0266\end{matrix} ] \qquad ( 6 )$$

The steering matrix J takes the form:

$$J = [ \begin{matrix}c & {s}^{*} \\ - s & c\end{matrix} ] \qquad ( 7 )$$

where c=cos θ, s=|sin θ|e^{jφ}. The beam may then be steered over all complex orthogonal space by varying θ and φ. This can be achieved any suitable means, for example by dynamically incrementing the individual values over pre-set ranges or by means of a look-up table having pre-set entries for θ and φ. The beam steering mechanism 30 determines the parameters x₁₁, x₁₂, x₂₁, x₂₂ of the individual data streams fed to the transmit antennas.

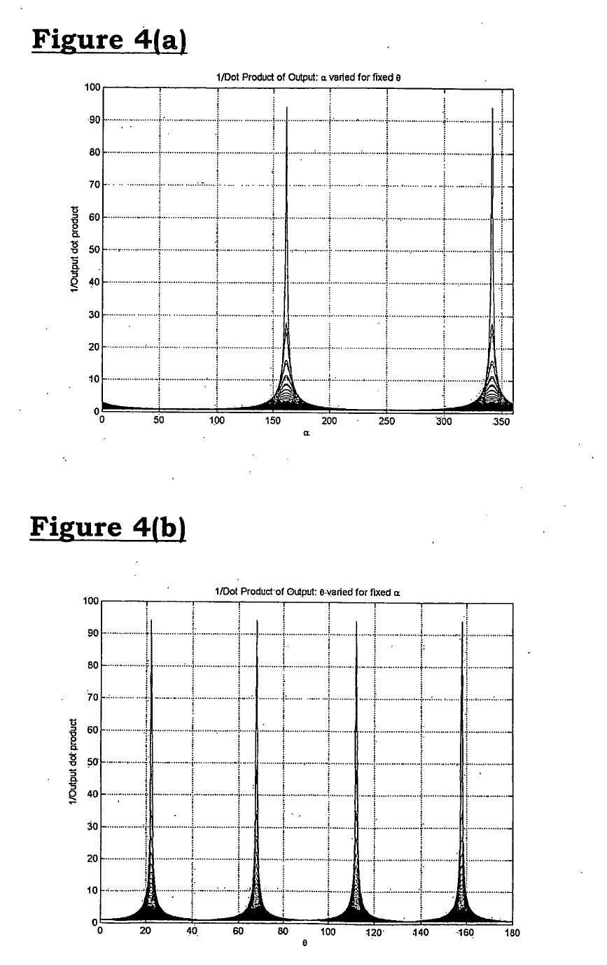

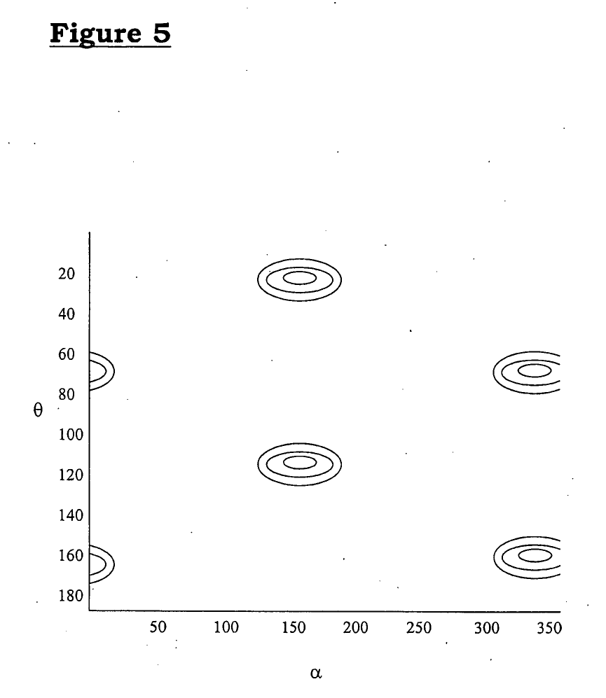

FIG. 4(a) shows results of steering over all φ space and measuring the dot product between resulting receiver beams; FIG. 4(b) shows the result of steering over all θ space and measuring the dot product between receiver beams. FIG. 5 shows a schematic plot of the combined (φ and θ) search space.

Together, the three plots illustrate how the peaks are the points at which appropriate values of θ and φ can be identified and used to construct the transmit beam-forming matrix V. U is then determined by the receiver output: at the peaks, J can be identified and hence the correct transmit beams weight matrix, V (=JB), is determined; U is then constructed from the signal vectors (magnitude and phase) observed at each receive antenna for the different transmit beams. The channel gain, Σ², may be constructed from the measured power on the two identified orthogonal receive beams. Thus the channel matrix M is effectively identified.

The information derived about the channel gain matrix Σ may be employed to determined whether and when channel gain falls below acceptable levels and hence when it may be appropriate not to use certain transmission beams. If the gain on a given transmit beam becomes too low so that its SNR becomes too low for data transmission at a given rate (modulation level) then use of that beam may be (temporarily) suspended. Hence this information may be used to support adaptive modulation across the MIMO channels. It also serves to identify the number of independent channels supported by the transmission medium at that time. It may be that no transmission is possible at all so that no use can be made of a specific transmitter/receiver beam pair. The matrix Σ effectively identifies how many MIMO channels are available at a given time and frequency.

For the specific channel matrix described above, the required parameters are θ=22.21° and φ=161.48°. Due to the additional ambiguity of the rotation angle then, as expected, two peaks are observed for φ and four peaks for θ.

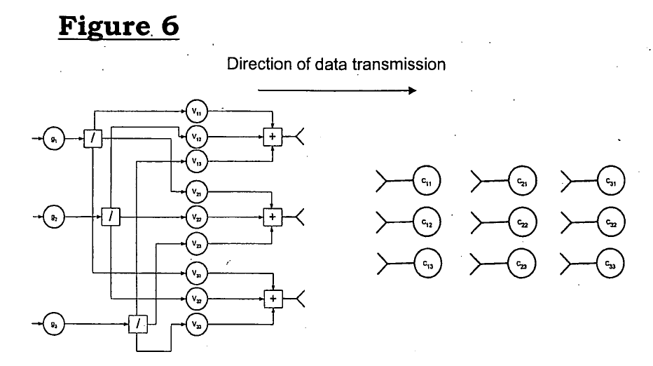

Whilst the detailed examples described relate to a system having two transmit antennas and two receive antennas, the method can of course be extended to larger systems and to systems having unequal numbers of transmit and receive antennas. In particular, referring to FIG. 6, an arrangement having three transmit and three receive antennas may be constructed.

Embodiments involving three transmit and three receive antennas involve choosing an orthogonal set of transmit weights, B, so that:

$${[ \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ]}^{H} [ \begin{matrix}{b}_{11} & {b}_{12} & {b}_{13} \\ {b}_{21} & {b}_{22} & {b}_{23} \\ {b}_{31} & {b}_{32} & {b}_{33}\end{matrix} ] = [ \begin{matrix}1 & 0 & 0 \\ 0 & 1 & 0 \\ 0 & 0 & 1\end{matrix} ] \qquad ( 8 )$$

The resulting orthogonal set of beams may be rotated through all three orthogonal planes using respective rotation matrices:

$$\begin{matrix}[ \begin{matrix}c & {s}^{*} & 0 \\ - s & c & 0 \\ 0 & 0 & 1\end{matrix} ] & ( 9 ) \\ [ \begin{matrix}1 & 0 & 0 \\ 0 & c & {s}^{*} \\ 0 & - s & c\end{matrix} ] & ( 10 ) \\ [ \begin{matrix}c & 0 & {s}^{*} \\ 0 & 1 & 0 \\ - s & 0 & c\end{matrix} ] & ( 11 )\end{matrix}$$

in which c=cos θ and s=sin θe^{jφ}. Extension to 4 by 4 systems and higher is straightforward and the details apparent to a person skilled in the art.

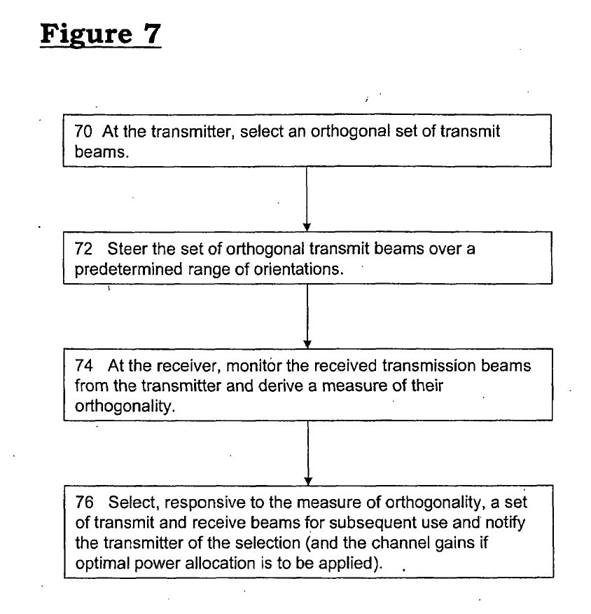

Referring now to FIG. 7, the method of channel selection then comprises the steps of:
At the transmitter, selecting an orthogonal set of transmit beams having corresponding transmit weights xᵢⱼ;
Steering the set of orthogonal transmit beams over a predetermined range of orientations. This may, for example, involve re-calculating a steering matrix J, or looking up predetermined successive values of J from a stored lookup table.
At the receiver, monitoring the received transmission beams from the transmitter and deriving a measure of their orthogonality;
Selecting, responsive to the measure of orthogonality, a set of transmission beams for subsequent use and notifying the transmitter of the selection.

The set of transmission beams, identified at the receiver end, may be communicated back to the transmitter by any suitable communications medium and encoding. The corresponding transmit weights xᵢⱼ correspond to the desired weights vᵢⱼ in transmit matrix V. Where a given transmit beam orientation is maintained at the transmitter for sufficiently long, the message sent to the transmitter may be a simple “stop” message to indicate to the transmitter that the current beams orientation is selected.

The method can be used not only upon initial set-up of a connection but also from time to time during the course of transmission since the channel characteristics may vary over time.

Unlike known systems which require transmission of data from only one transmit antenna at a time, the present method employs transmission of training sequences on multiple antennas simultaneously, in the same way as for live data transmission. This means that there is no need for the separate circuitry, present in known systems, to feed training data to individual transmit antennas. By effectively configuring whole beams formed by multiple antennas acting together, rather than configuring individual transmit antenna/receive antenna pairs, the number of training sequences may also be reduced.

One particular application of this technique is in the field of MIMO communications for advanced Wireless Local Area Network (WLAN) and Wireless Personal Area Networks (WPAN). Upgrades to current standards in this market (namely the 802.11x family and Bluetooth) are currently under consideration by the relevant standard-setting bodies.

Since the method directly finds the channel in its most “natural” form and enables an enhanced optimal communication system to be employed, the method is stand-alone in the sense that all processing is done at the transmit and receive antennas. SISO communications can therefore be continued whilst MIMO channel estimation is in progress.

Extension to four transmitters or four receivers and higher is straightforward.

In the methods described above, a search procedure is employed for calculating the correct steering parameters for the input whereby it may be necessary to search across all space for a suitable solution. However the present inventors have further realised that the steering parameters can be determined through a closed mathematical procedure by deriving an expression for the dot product.

Considering the complex 2×2 case, and explicitly writing in terms of the SVD of the channel matrix, the output from the two transmit beams defined by the matrix B_{T} gives:

$$\begin{matrix}{B}_{R} = [ \begin{matrix}{b}_{11} & {b}_{12} \\ {b}_{21} & {b}_{22}\end{matrix} ] \\ = {[ \begin{matrix}{u}_{11} & {u}_{12} \\ {u}_{21} & {u}_{22}\end{matrix} ] [ \begin{matrix}{σ}^{1} & 0 \\ 0 & {σ}^{2}\end{matrix} ] [ \begin{matrix}{v}_{11} & {v}_{12} \\ {v}_{21} & {v}_{22}\end{matrix} ]}^{H} [ \begin{matrix}cos θ & sin {θe}^{- jφ} \\ - sin {θe}^{jφ} & cos θ\end{matrix} ] \\ [ \begin{matrix}1 & 0 \\ 0 & 1\end{matrix} ]\end{matrix} \qquad ( 12 )$$

where B_{T} is chosen to be an orthogonal matrix, equal to the identity matrix:

$${B}_{T =} [ \begin{matrix}1 & 0 \\ 0 & 1\end{matrix} ] \qquad ( 13 )$$

Letting:

x₁=u₁₁σ₁v₁₁*

x₂=u₁₁σ₁v₂₁*

x₃=u₁₂σ₂v₁₂*

x₄=u₁₂σ₂v₂₂*

x₅=u₂₁σ₁v₁₁*

x₆=u₂₁σ₁v₂₁*

x₇=u₂₂σ₂v₁₂*

x₈=u₂₂σ₂v₂₂* (14)

gives:

$$\begin{matrix}[ \begin{matrix}{b}_{11} \\ {b}_{21}\end{matrix} ] = [ \begin{matrix}{x}_{1} cos θ - {x}_{2} sin {θe}^{j θ} + {x}_{3} cos θ - {x}_{4} sin {θe}^{jϕ} \\ {x}_{5} cos θ - {x}_{6} sin {θe}^{j θ} + {x}_{7} cos θ - {x}_{8} sin {θe}^{jφ}\end{matrix} ] & ( 15 ) \\ [ \begin{matrix}{b}_{12} \\ {b}_{22}\end{matrix} ] = [ \begin{matrix}{x}_{1} sin {θe}^{- j φ} + {x}_{2} cos θ + {x}_{3} sin {θe}^{- j φ} + {x}_{4} s cos θ \\ {x}_{5} sin {θe}^{- j φ} + {x}_{6} cos θ + {x}_{7} sin {θe}^{- j φ} + {x}_{8} cos θ\end{matrix} ] & ( 16 )\end{matrix}$$

Computing the dot product of the receive beams gives an equation of the form:

$$[ \begin{matrix}{b}_{11}^{*} & {b}_{21}^{*} ] [ \begin{matrix}{b}_{12} \\ {b}_{22}\end{matrix} ] =\end{matrix} {y}_{1} {sin}^{2} θ {e}^{- 2 j φ} - {y}_{1}^{*} {cos}^{2} θ + {y}_{2} cos {θsinθe}^{- jφ} \qquad ( 17 )$$

where:

$${y}_{1} = - ( {x}_{2}^{*} {x}_{1} + {x}_{2}^{*} {x}_{3} + {x}_{4}^{*} {x}_{1} + {x}_{4}^{*} {x}_{3} + {x}_{6}^{*} {x}_{5} + {x}_{6}^{*} {x}_{7} + {x}_{8}^{*} {x}_{5} + {x}_{8}^{*} {x}_{7} ) \\ {y}_{2} = {x}_{1}^{*} {x}_{1} + {x}_{1}^{*} {x}_{3} - {x}_{2}^{*} {x}_{2} - {x}_{2}^{*} {x}_{4} + {x}_{3}^{*} {x}_{1} + {x}_{3}^{*} {x}_{3} - {x}_{4}^{*} {x}_{2} - {x}_{4}^{*} {x}_{4} + {x}_{5}^{*} {x}_{5} + {x}_{5}^{*} {x}_{7} - {x}_{6}^{*} {x}_{6} - {x}_{6}^{*} {x}_{8} + {x}_{7}^{*} {x}_{5} + {x}_{7}^{*} {x}_{7} - {x}_{8}^{*} {x}_{6} - {x}_{8}^{*} {x}_{8} \qquad ( 18 )$$

Consequently the dot product can be used to identify y₁ when θ=90° or φ=0° (or −y₁* when θ=0°). If θ=45° or φ=0° then the dot product gives terms j/m(y₁)+y₂/2 from which y₂ can be calculated. As in the real case this equation can be simplified by using identities:

cos² θ=0.5(1+cos 2θ)

sin² θ=0.5(1−cos 2θ)

cos θ sin θ=0.5 sin 2θ (19)

to give:

$$[ \begin{matrix}{b}_{11}^{*} & {b}_{21}^{*} ] [ \begin{matrix}{b}_{12} \\ {b}_{22}\end{matrix} ] =\end{matrix} \frac{{y}_{1}}{2} ( 1 - cos 2 θ ) {e}^{- 2 j φ} - \frac{{y}_{1}^{*}}{2} ( 1 + cos 2 θ ) + \frac{{y}_{2}}{2} sin 2 {θe}^{- jφ} \qquad ( 20 )$$

In this case the aim is to identify the parameters θ and φ such that equation (20) is zero. Thus equation (20) can be rearranged as:

$$\frac{{y}_{1} {e}^{- jφ}}{2} ( 1 - cos 2 θ ) - \frac{{( {y}_{1} {e}^{- jφ} )}^{*}}{2} ( 1 + cos 2 θ ) = - \frac{{y}_{2}}{2} sin 2 θ \qquad ( 21 )$$

or:

$$\underbrace{( \frac{{y}_{1} {e}^{- jφ}}{2} - \frac{{( {y}_{1} {e}^{- jφ} )}^{*}}{2} )}_{imaginary} - \underbrace{cos 2 θ ( \frac{{y}_{1} {e}^{- jφ}}{2} + \frac{{( {y}_{1} {e}^{- jφ} )}^{*}}{2} )}_{real} = \underbrace{- \frac{{y}_{2}}{2} sin 2 θ}_{real} \qquad ( 22 )$$

Letting:

i y₁=y₁^{R}+jy₁^{l}

i y₂=y₂^{R}+jy₂^{l} (23)

and equating real an imaginary terms of equation (22) gives:

$$\begin{matrix}{y}_{1}^{R} cos φ + {y}_{1}^{I} sin φ = \frac{{y}_{2}^{R}}{2} tan 2 θ & ( 24 ) \\ {y}_{1}^{I} cos φ + {y}_{1}^{R} sin φ = - \frac{{y}_{2}^{I}}{2} sin 2 θ = 0 & ( 25 )\end{matrix}$$

From equation (25) it is possible to derive a solution for φ as:

$$\hat{φ} = arctan ( \frac{{y}_{1}^{I}}{{y}_{1}^{R}} ) \qquad ( 26 )$$

Substituting this result back into equation (24) gives:

$$\hat{φ} = \frac{1}{2} arctan ( ( \frac{2}{{y}_{1}^{R}} ) ( {y}_{1}^{R} cos \hat{φ} + {y}_{1}^{I} sin \hat{φ} ) ) \qquad ( 27 )$$

Consequently the correct transmit beams may be found according to equation (27) and the singular values from the square roots of the receive beam dot products.

By way of example, consider the following case in which the channel matrix is given by:

$$H = [ \begin{matrix}1.0727 - j0 .3473 & 0.2146 + j0 .2551 \\ 0.7122 + j0 .6134 & - 0.5778 - j0 .0568\end{matrix} ] \qquad ( 28 )$$

With θ=0° and φ=0° then y₁* is found to be 0.3047−j0.6621. Similarly, if θ=90° and φ=0° then y₁ is found to be 0.3047+j0.6621. With if θ=45° and φ=0° then y₂ is found to be 1.7066.

Solving for \hat{φ} using equation (26) gives:

$$\begin{matrix}\hat{φ} = arctan ( \frac{{y}_{1}^{I}}{{y}_{1}^{R}} ) \\ = arctan ( \frac{0.6621}{0.3047} ) \\ = 65.29 °\end{matrix} \qquad ( 29 )$$

and from equation (27) we have:

$$\begin{matrix}\hat{θ} = \frac{1}{2} arctan ( ( \frac{2}{{y}_{2}^{R}} ) ( {y}_{1}^{R} cos \hat{φ} + {y}_{1}^{I} sin \hat{φ} ) ) \\ = \frac{1}{2} arctan ( ( \frac{2}{1.7066} ) ( 0.3047 \times 0.418 + 0.6621 \times 0.908 ) ) \\ = 20.25 °\end{matrix} \qquad ( 30 )$$

Thus the required steering matrix is:

$$[ \begin{matrix}cos \hat{θ} & sin \hat{θ} {e}^{- j \hat{φ}} \\ - sin \hat{θ} {e}^{jφ} & cos \hat{θ}\end{matrix} ] = [ \begin{matrix}0.9382 & 0.1447 - j0 .3145 \\ - 0.1447 - j0 .3145 & 0.9382\end{matrix} ] \qquad ( 31 )$$

The outputs at the receiver are given by:

$${B}_{R} = [ \begin{matrix}1.0555 - j0 .4302 & 0.2474 - j0 .1482 \\ 0.7339 + j0 .7654 & - 0.2461 - j0 .1885\end{matrix} ] \qquad ( 32 )$$

which are orthogonal vectors since:

$${B}_{R}^{H} {B}_{R} = [ \begin{matrix}2.4237 & 0 \\ 0 & 0.1793\end{matrix} ] \qquad ( 33 )$$

Consequently, the singular values of the channel matrix are \sqrt{2.4237}=1.557 and \sqrt{0.1793}=0.423.

This approach replaces the search process, over all θ and φ to find a solution which satisfies the orthogonality condition, by the very much simpler task of calculating values of y₁ and y₂ from two selections of θ and φ. From these two orientations, and using closed form solutions, values of \hat{θ} and \hat{φ} can be calculated which ensure orthogonality.

This latter approach therefore significantly reduces the number of transmit orientations which must be steered through to characterise the channel, with corresponding reduction in transmission bandwidth lost to revenue-bearing traffic. Furthermore, the additional calculations required in this approach are relatively straightforward, and could be implemented—at least in part—by lookup tables to further reduce calculation delays and hence channel characterisation delays.

In a further embodiment, a modulation level of at least one transmit beam is selected responsive to a characteristic of the received signals. This characteristic may, for example, be the complex channel gain, Σ, associated with transmissions. In some cases a modulation level of zero may be assigned, for example where the complex channel gain is already very small.

In general optimal power allocation may be made to the various channels based on the measure channel gains using known techniques such as water-filling.

Any range or device value given herein may be extended or altered without losing the effect sought, as will be apparent to the skilled person for an understanding of the teachings herein.

1. A method of transmitting signals for a multiple-input, multiple-output communications system, the method comprising the steps of:
steering a set of mutually orthogonal transmit beams over a plurality of predetermined orientations;
selecting a preferred orientation of the mutually orthogonal transmit beams responsive to a characteristic of signals received, at a receiver, from the transmit beams.

2. A method according to claim 1 in which the plurality of predetermined orientations substantially spans the available transmit space.

3. A method according to claim 1 in which the characteristic is a measure of orthogonality of the received signals.

4. A method according to claim 1 in which the selected orientation is one of the plurality of predetermined orientations.

5. A method according to claim 1 in which the selected orientation need not be one of the plurality of predetermined orientations.

6. A method according to claim 1 in which the selected orientation is computed from characteristics of the received signals.

7. A method according to claim 1 in which the plurality of predetermined orientations is insufficient to substantially span the transmit space.

8. A method according to claim 7 in which the plurality of predetermined orientations consists of two orientations.

9. A method according to claim 7 in which the preferred orientation is selected responsive to a mathematical calculation applied to a characteristic of the received signals.

10. A method according to claim 1 in which the number of transmit beams is one of 2, 3, and 4.

11. A method according to claim 1 in which selection is made responsive to receipt of an indication identifying a transmit orientation.

12. A method according to claim 1 used in a wireless communications system.

13. A method according to claim 1 in which transmission of data continues during steering of the transmit beams.

14. A method according to claim 1 in which a modulation level of at least one transmit beam is selected responsive to a characteristic of the received signals.

15. A method according to claim 14 in which the characteristic is complex channel gain.

16. A method according to claim 14 in which a modulation level is selected to be zero.

17. A method according to claim 16 in which the modulation level is selected to be zero where the complex channel gain is measured to be every small.

18. A receiver for a multiple-input, multiple-output communications system, the receiver comprising:
receive apparatus arranged to receive signals from a set of mutually orthogonal transmit beams steered over a plurality of predetermined orientations;
apparatus arranged to determine, for each predetermined orientation, a characteristic of the signals received by the receive apparatus, the characteristic being indicative of quality of the signals received by the receive apparatus;
apparatus arranged to transmit at least one of (a) the characteristic of a plurality of, or all, predetermined orientations and (b) an indication of a preferred orientation, the indication being derived responsive to the characteristics of the signals received.

19. A transmitter for a multiple-input, multiple-output communications system, the transmitter comprising:
beam steering apparatus arranged to steer a set of mutually orthogonal transmit beams over a plurality of predetermined orientations;
selection apparatus for selecting a preferred orientation of the mutually orthogonal transmit beams responsive to a characteristic of signals received, at a receiver, from the transmit beams.

20. A communications system comprising a receiver according to claim 18 and a transmitter for a multiple-input, multiple-output communications system, the transmitter comprising:
beam steering apparatus arranged to steer a set of mutually orthogonal transmit beams over a plurality of predetermined orientations;
selection apparatus for selecting a preferred orientation of the mutually orthogonal transmit beams responsive to a characteristic of signals received, at a receiver, from the transmit beams.

21. Apparatus according to claim 18 in which the apparatus is portable apparatus.

22. A program for a computer for a multiple-input, multiple-output communications system, the program comprising code portions arranged to:
steer a set of mutually orthogonal transmit beams over a plurality of predetermined orientations;
select a preferred orientation of the mutually orthogonal transmit beams responsive to a characteristic of signals received, at a receiver, from the transmit beams.

23. A program for a computer for a multiple-input, multiple-output communications system, the program comprising code portions arranged to:
receive signals from a set of mutually orthogonal transmit beams steered over a plurality of predetermined orientations;
determine, for each predetermined orientation, a characteristic of the signals received by the receive apparatus, the characteristic being indicative of quality of the signals received by the receive apparatus;
transmit at least one of (a) the characteristic of a plurality of, or all, predetermined orientations and (b) an indication of a preferred orientation, the indication being derived responsive to the characteristics of the signals received.

24. A signal for a multiple-input multiple-output communications system, the signal comprising a plurality of mutually orthogonal transmit beams carrying a training sequence, the transmit beams being steered over a predetermined set of orientations.

25. A communications service provided over a communications network arranged to perform the method according to claim 1.
